(19) United States
(12) Patent Application Publication
(10) Pub. No.: US 2009/0021165 A1
(43) Pub. Date: Jan. 22, 2009

(54) PLASMA DISPLAY PANEL AND METHOD OF MANUFACTURING THE SAME

(76) Inventors: Tae-Jung Chang, Yongin-si (KR); Jeong-Nam Kim, Yongin-si (KR); Won-Seok Yoon, Yongin-si (KR); Min-Han Kim, Yongin-si (KR); Jin-Ho Bin, Yongin-si (KR)

Correspondence Address: CHRISTIE, PARKER & HALE, LLP, PO BOX 7068, PASADENA, CA, 91109-7068, US

(21) Appl. No.: 12/133,271

(22) Filed: Jun. 4, 2008

(30) Foreign Application Priority Data
Jul. 19, 2007 (KR) 10-2007-0072211

(51) Int. Cl. H01J 17/49; H01J 9/02

(52) U.S. Cl. 313/582; 445/25

(57) ABSTRACT

A plasma display panel is provided having a first substrate and a second substrate facing the first substrate with an interval therebetween. An address electrode extends in a first direction on the first substrate. A dielectric layer is on the first substrate covering the address electrode. One or more barrier ribs are on the dielectric layer to define a discharge cell in relation to the address electrode. A phosphor layer is in the discharge cell. A first electrode and a second electrode extend in a second direction on the second substrate corresponding to the discharge cell. The second direction crosses the first direction. The dielectric layer includes a flat surface facing the discharge cell.

### CROSS-REFERENCE TO RELATED APPLICATION

This application claims priority to and the benefit of Korean Patent Application No. 10-2007-0072211, filed in the Korean Intellectual Property Office on Jul. 19, 2007, the entire content of which is incorporated herein by reference.

### BACKGROUND OF THE INVENTION

1. Field of the Invention

The present invention relates to a plasma display panel (PDP) and a method of manufacturing the same.

2. Description of the Related Art

Generally, a PDP generates plasma using gas discharge, excites phosphors using vacuum ultra-violet rays emitted from the plasma, and realizes an image using red, green, and blue visible light that is generated when the excited phosphors are stabilized.

In an alternating current PDP, address electrodes are formed on a rear substrate and a dielectric layer is formed on the rear substrate to cover the address electrodes. Barrier ribs are disposed on the dielectric layer between the address electrodes. The barrier ribs are arranged in a stripe pattern, and red, green, and blue phosphor layers are formed on the barrier ribs.

Display electrodes, each of which has paired sustain and scan electrodes, are disposed on the front substrate facing the rear substrate. The display electrodes extend in a direction intersecting the address electrodes, and are covered by a dielectric layer and a MgO protective layer.

The discharge cells are formed to correspond to intersecting regions at which the address electrodes formed on the rear substrate intersect the pairs of the sustain and scan electrodes of the display electrodes formed on the front substrate. Millions or more of the discharge cells are arranged in a matrix pattern in the PDP.

A method of manufacturing the PDP includes a process for manufacturing the front substrate, a process for manufacturing the rear substrate, a process for sealing the front and rear substrates together, and a process for exhausting and injecting gas.

In the process for manufacturing the rear substrate, the address electrodes are formed and the dielectric layer is formed to cover the address electrodes. Next, the barrier ribs are formed on the dielectric layer, and phosphor layers are formed on sidewalls of the barrier ribs and the dielectric layer.

After the dielectric layer, the barrier ribs, and the phosphor layers are formed, processes are performed for baking the dielectric layer, the barrier ribs, and the phosphor layers. The conventional processes have a lengthy process time.

### SUMMARY OF THE INVENTION

Exemplary embodiments of the present invention provide a PDP and a method of manufacturing the same, which can reduce a general process time by reducing a baking process time.

A plasma display panel is provided having a first substrate and a second substrate facing the first substrate with an interval therebetween. An address electrode extends in a first direction on the first substrate. A dielectric layer is on the first substrate covering the address electrode. One or more barrier ribs are on the dielectric layer to define a discharge cell in relation to the address electrode. A phosphor layer is in the discharge cell. A first electrode and a second electrode extend in a second direction on the second substrate corresponding to the discharge cell. The second direction crosses the first direction. The dielectric layer includes a flat surface facing the discharge cell.

In an exemplary embodiment of the present invention, the flat surface corresponds to a central portion of the discharge cell.

In an exemplary embodiment of the present invention, the dielectric layer includes a groove on at least one side of the discharge cell.

In an exemplary embodiment of the present invention, the groove is on an outer area of the discharge cell.

In an exemplary embodiment of the present invention, the groove is on a line extending from an inner surface of a barrier rib of the one or more barrier ribs.

In an exemplary embodiment of the present invention, the phosphor layer includes a flat surface on the flat surface of the dielectric layer and a protrusion in the groove of the dielectric layer.

In an exemplary embodiment of the present invention, the protrusion is on an outer area of the discharge cell.

In an exemplary embodiment of the present invention, the protrusion is formed on a line extending from an inner surface of a barrier rib of the one or more barrier ribs.

A method of manufacturing a plasma display panel is provided. A first substrate and a second substrate are prepared. The first substrate and the second substrate are sealed together to face each other with an interval therebetween. Preparing the first substrate includes printing a dielectric paste layer on the first substrate to cover address electrodes on the first substrate; drying the printed dielectric paste layer; depositing a first dry film resist on the dielectric paste layer; forming a first resist pattern on the first dry film resist, the first resist pattern corresponding to a pattern of discharge cells; printing a barrier rib paste on the first dry film resist; drying the printed barrier rib paste to form a barrier rib paste layer; depositing a second dry film resist on the barrier rib paste layer; forming a second resist pattern on the second dry film resist, the second resist pattern corresponding to a pattern of barrier ribs; etching the barrier rib paste layer using the second resist pattern to form the barrier ribs; delaminating the first resist pattern and the second resist pattern; and baking the dielectric paste layer and the barrier rib paste layer.

In an exemplary embodiment of the present invention, depositing the first dry film resist includes laminating the first dry film resist on the dielectric paste layer, wherein forming a first resist pattern includes exposing and developing the first dry film resist laminated on the dielectric paste layer.

In an exemplary embodiment of the present invention, depositing the second dry film resist includes laminating the second dry film resist on the barrier rib paste layer. Forming a second resist pattern includes exposing and developing the second dry film resist laminated on the barrier rib paste layer.

In an exemplary embodiment of the present invention, the barrier ribs are formed by removing the barrier rib paste layer using a sandblasting method.

In an exemplary embodiment of the present invention, the dielectric paste layer and the barrier rib paste layer are simultaneously baked through a single baking process.

### BRIEF DESCRIPTION OF THE DRAWINGS

FIG. 1 is an exploded perspective view of a PDP according to an exemplary embodiment of the present invention.

FIG. 2 is a sectional view of the PDP taken along line II-II of FIG. 1.

FIG. 3 is a top plan view of an arrangement of discharge cells and electrodes.

FIG. 4 is a process diagram illustrating a method of making a PDP according to an exemplary embodiment of the present invention.

FIG. 5 is a sectional view taken along line V-V of FIG. 1.

FIG. 6 is a sectional view of a PDP according to a second exemplary embodiment of the present invention.

### DETAILED DESCRIPTION

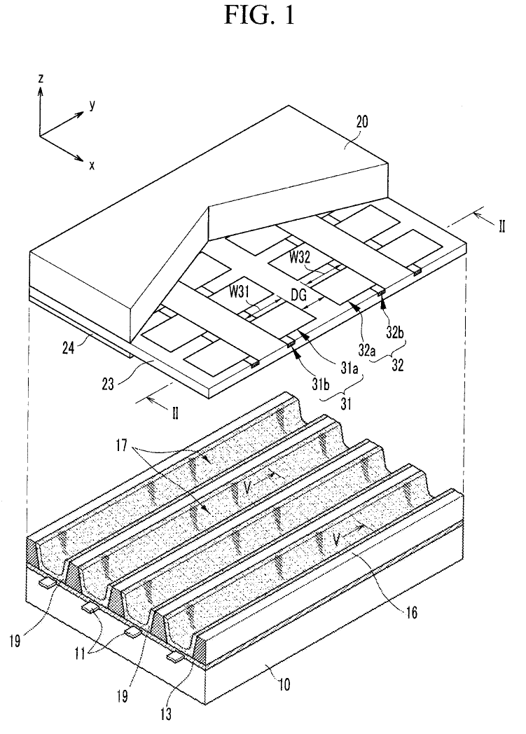

FIG. 1 is an exploded perspective view of a PDP according to an exemplary embodiment of the present invention. The PDP includes rear and front substrates 10, that face each other and are sealed together. Barrier ribs 16 are formed between the rear and front substrates 10, 20.

The barrier ribs 16 are formed having a height (e.g., predetermined height) to define a plurality of discharge cells 17. The discharge cells 17 are filled with a discharge gas including neon (Ne) and xenon (Xe), for example, to generate vacuum ultraviolet rays. Phosphor layers 19 are formed in the respective discharge cells 17.

In order to realize an image using gas discharge, the PDP further includes address electrodes 11, first electrodes (hereinafter referred to as “sustain electrodes”) 31, and second electrodes (hereinafter referred to as “scan electrodes” 32), all of which are arranged about the discharge cells 17 between the rear and front substrates 10, 20.

For example, the address electrodes 11 are formed on an inner surface of the rear substrate 10. The address electrodes 11 extend in a first direction (a y-direction in FIG. 1) so that each of the address electrodes 11 continuously corresponds to the discharge cells 17 that are successively arranged in the y-direction. Further, the address electrodes 11 are spaced apart from each other in parallel in a second direction (an x-direction in FIG. 1) about the discharge cells adjacently arranged in the second direction.

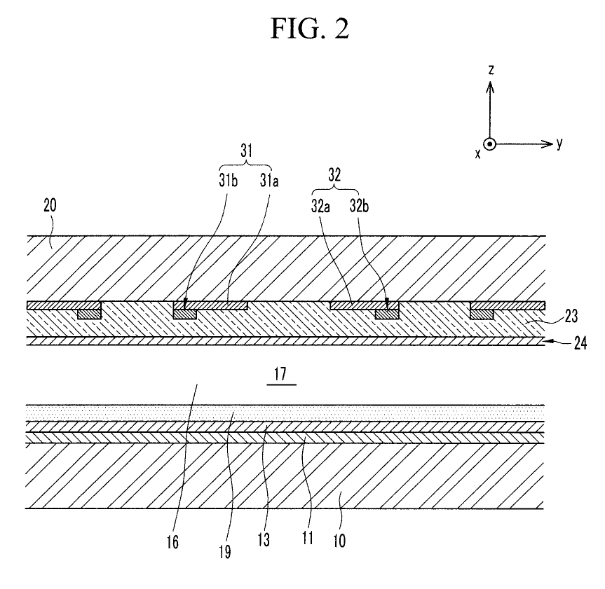

FIG. 2 is a sectional view of the PDP taken along line II-II of FIG. 1. A first dielectric layer 13 is formed on the inner surface of the rear substrate 10 to cover the address electrodes 11. The first dielectric layer 13 prevents cations or electrons from directly colliding with the address electrodes 11, thereby preventing the address electrodes 11 from being damaged and providing a place where wall charges are formed and accumulated.

The address electrodes 11 are arranged on the rear substrate 10 so as to not interfere with the emission of the visible light in a frontward direction. Therefore, the address electrodes 11 may be formed of a non-transparent material. For example, the address electrodes 11 may be formed of a metal having excellent electrical conductivity.

The barrier ribs 16 define the discharge cells 17 in relation to the address electrodes 11. The barrier ribs 16 are substantially formed on the first dielectric layer 13. Therefore, the discharge cells 17 are defined by the barrier ribs 16 and the first dielectric layer 13 on the rear substrate 10.

The phosphor layers 19 are formed on the sidewalls of the barrier ribs 16 and a surface of the first dielectric layer 13 between the barrier ribs 16. For example, the phosphor layers 19 are formed by depositing a phosphor paste and drying and baking the deposited phosphor paste.

The phosphor layers 19 formed on the discharge cells 17 arranged in the y-direction are formed of phosphors emitting visible light of the same color. The phosphor layers 19 formed on the discharge cells 17 arranged in the x-direction are formed of phosphors emitting visible light of different colors (i.e., red, green, and blue colors).

The sustain electrodes 31 and the scan electrodes 32 are formed on the inner surface of the front substrate 20 to form a surface discharge configuration corresponding to the discharge cells 17 for the gas discharge.

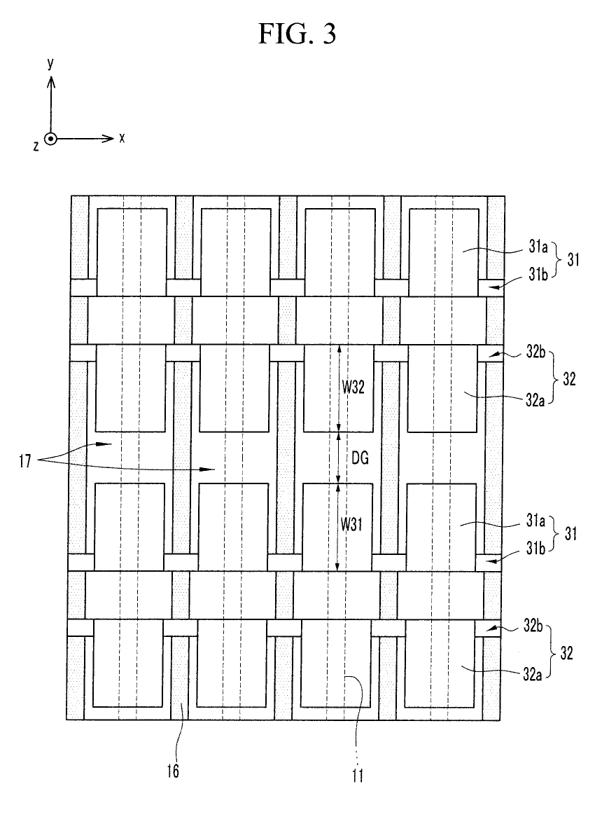

FIG. 3 is a top plan view illustrating an arrangement of the barrier ribs and the electrodes. The sustain electrodes 31 and the scan electrodes 32 are formed extending in the x-direction intersecting the address electrodes 11. Each of the sustain electrodes 31 includes a transparent electrode 31a generating a discharge and a bus electrode 31b applying a voltage signal to the transparent electrode 31a. Likewise, each of the scan electrodes 32 includes a transparent electrode 32a generating a discharge and a bus electrode 32b applying a voltage signal to the bus electrode 32a.

Because the transparent electrodes 31a, 32a are disposed in the discharge cells 17, they are formed of a transparent material such as indium tin oxide (ITO) to ensure sufficient aperture ratios of the discharge cells 17.

The bus electrodes 31b, 32b are formed of metal having excellent electrical conductivity to compensate for a high electrical resistance of the transparent electrodes 31a, 32a. The bus electrodes 31b, 32b can include a dark layer to reduce external light reflectivity.

The transparent electrodes 31a, 32a protrude in the y-direction from outer areas of the discharge cells 17 to centers of the discharge cells 17. The transparent electrodes 31a, 32a respectively have widths W31 and W32. A discharge gap DG is formed at a center of each discharge cell 17 between the corresponding transparent electrodes 31a, 32a.

The bus electrodes 31b, 32b extend in the x-direction at the outer areas of the discharge cells 17 and are disposed on the transparent electrodes 31a, 32a. Accordingly, the voltage signals applied to the bus electrodes 31b, 32b are applied to the respective transparent electrodes 31a, 32a.

Each of the sustain and scan electrodes 31, 32 may respectively include the bus electrodes 31b, 32b and a protrusion electrode that protrudes from the bus electrodes 31b, 32b into the discharge cell 17. The protrusion electrodes are formed of a material identical to that of the bus electrodes 31b, 32b. In this case, the protrusion electrodes, formed of a material identical to the bus electrodes, replace the transparent electrodes to form the discharge gap therebetween.

Referring to FIG. 1 and FIG. 2, the sustain and scan electrodes 31, 32 intersect the address electrodes 11 and face each other in the discharge cells 17. A second dielectric layer 23 is formed on the front substrate 20 to cover the sustain and scan electrodes 31, 32. The second dielectric layer 23 protects the sustain and scan electrodes 31, 32 from the gas discharge and provides a place for forming and accumulating the wall charges.

A protective layer 24 is formed to cover the second dielectric layer 23. For example, the protective layer 24 is formed of transparent MgO to increase a secondary electron emission coefficient during the discharge.

For example, describing the driving of the PDP, a reset discharge occurs by a reset pulse applied to the scan electrodes 32 in a reset period. In a scan period following the reset period, an address discharge occurs by a scan pulse applied to the scan electrodes 32 and an address pulse applied to the address electrodes 11. After the above, a sustain discharge occurs by a sustain pulse applied to the sustain and scan electrodes 31, 32.

The sustain and scan electrodes 31, 32 function to apply the sustain pulse required for the sustain discharge. The scan electrodes 32 function to apply the scan and reset pulses. The address electrodes 11 function to apply the address pulse.

The functions of the sustain electrode 31, the scan electrode 32, and the address electrode 11 may vary according to applied voltage waveforms, and therefore the functions are not limited as above.

The PDP selects the discharge cells 17 that will be turned on by the address discharge occurring by the interaction between the address and scan electrodes 11, 32, and drives the selected discharge cells 17 by the sustain discharge occurring by the interaction between the sustain and scan electrodes 31, 32.

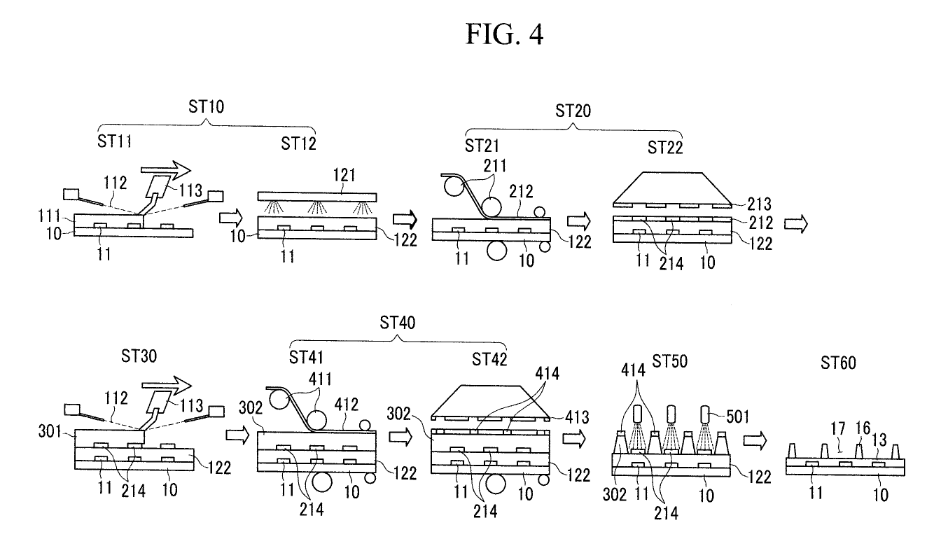

FIG. 4 is a flowchart illustrating a method of manufacturing the PDP according to an exemplary embodiment of the present invention. The PDP depicted in FIG. 1, FIG. 2, and FIG. 3 can be made by a method of this exemplary embodiment. For convenience, the structure of the PDP will be further described while describing the method of this exemplary embodiment.

The rear and front substrates 10, 20 are manufactured by separate processes and sealed together with each other, after which a space defined between the rear and front substrates 10, 20 is exhausted and gas is filled in the space. Because the processes for making the front and rear substrates 20, 10, and the sealing, gas exhausting, and gas filling processes are well known in the art, a detailed description thereof will be omitted herein. Herein, the process for making the rear substrate 10 will be described.

The process for making the rear substrate 10 includes a dielectric layer printing/drying step ST10, a first resist pattern forming step ST20, a barrier rib layer printing/drying step ST30, a second resist pattern forming step ST40, a barrier rib forming step ST50, and a delaminating/baking step ST60.

In a state where the address electrodes 11 are formed on the rear substrate 10, the rear substrate 10 goes to the dielectric printing/drying step ST10. In the dielectric layer printing/drying step ST10, a dielectric paste 111 is printed on the inner surface of the rear substrate 10 to cover the address electrodes 11. For example, the dielectric layer printing/drying step ST10 includes a dielectric paste printing step ST11 and a paste layer drying step ST12. In the dielectric paste printing step ST11, the dielectric paste 111 is printed on the rear substrate 10 to cover the address electrodes 11 using a squeegee 113 and a screen mask 112. In the drying step ST12, a dielectric paste layer 122 printed on the rear substrate 10 is dried by a heating lamp 121 in a drying furnace. The dielectric paste layer 122 is baked to form the first dielectric layer 13 of the PDP.

In the first resist pattern forming step ST20, a discharge cell 17 pattern is formed by depositing a first dry film resist 212 on the dielectric paste layer 122. The first resist pattern forming step ST20 includes a laminating step ST21 and an exposing/developing step ST22. In the laminating step ST21, the first dry film resist 212 is laminated on the dielectric paste layer 122 using a laminator 211. In the exposing/developing step ST22, the first dry film resist 212 is exposed to the light through a mask 213 by an exposure apparatus, and developed by a developing apparatus. The first dry film resist 212 is exposed by the light through the mask 213 to form a first resist pattern 214 corresponding to the pattern of the discharge cells 17.

In the barrier rib layer printing/drying step ST30, a barrier rib paste 301 is printed and dried on the dielectric paste layer 122 and the first resist pattern 214 to form a barrier rib paste layer 302. The first dry film resist 212 has already been formed the first resist pattern 214. The barrier rib layer printing/drying step ST30 may be processed through a method identical to that of the dielectric printing/drying step ST10. For convenience, in FIG. 4, the drying step is omitted and only the barrier rib paste printing step is shown.

The second resist pattern forming step ST40 may be processed by a method identical to that of forming the first resist pattern forming step ST20. The second resist pattern forming step ST40 includes a laminating step ST41 and an exposing/developing step ST42. In the laminating step ST41, a second dry film resist 412 is laminated on the barrier rib paste layer 302 using a laminator 411.

In the exposing/developing step ST42, the second dry film resist 412 is exposed and developed by exposing and developing apparatuses. That is, the second dry film resist 412 is exposed to a light through a mask 413 and developed to form a second resist pattern 414 corresponding to the pattern of the barrier ribs 16. The first resist pattern formed by the first dry film resist 212 and the second resist pattern 414 formed by the second dry film resist 212 are alternately disposed.

In the barrier rib forming step ST50, the barrier rib paste layer 302 is etched using the second resist pattern 414 and baked to form the barrier ribs 16 of the PDP. For example, in the barrier rib forming step ST50, the etching may be preformed by a sandblasting process using a sandblaster machine 501. In the barrier rib forming step ST50, the barrier rib paste layer 302 is etched using the second resist pattern 414 until the sand particles reach the first resist pattern 214.

In the sandblasting process, the first resist pattern 214 prevents the sand particles from etching the dielectric paste layer 122. When the first and second resist patterns 214, 414 are desirably aligned with each other, the first resist pattern 214 can stably protect the dielectric paste layer 122 from the sand particles.

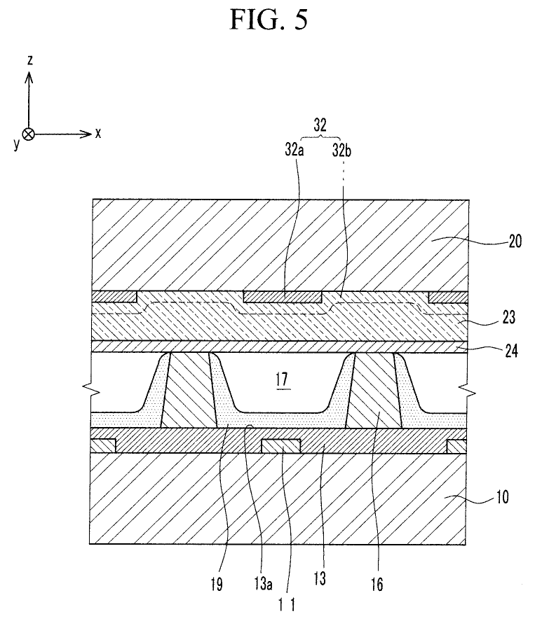

The dielectric paste layer 122 of FIG. 4 changes into the first dielectric layer 13 of FIG. 5 through the delaminating/baking step ST60. Referring to FIG. 5, the first dielectric layer 13 includes a flat surface 13a facing the discharge cells 17 in parallel. The flat surface 13a is formed about at least central portions of the discharge cells 17. The flat surface 13a is formed about all of the discharge cells 17.

The delaminating/baking step ST60 includes a resist delaminating step and a baking step. For convenience, the resist delaminating step and the baking step are illustrated as a single step in FIG. 4. In the delaminating step, the first resist pattern 214 formed on the dielectric paste layer 122 by the first dry film resist 212, and the second resist pattern 414 formed on the barrier rib paste layer 302 by the second dry film resist 412 are delaminated. Accordingly, the dielectric paste layer 122 and the barrier rib paste layer 302 that are not baked and the address electrodes 11 remain on the rear substrate 10.

In the baking step, the dielectric paste layer 122 changes to the first dielectric layer 13 and the barrier rib paste layer 302 changes to the barrier ribs 16. That is, the dielectric paste layer 122 and the barrier rib paste layer 302 are baked through a single baking process to thereby form the first dielectric layer 13 and the barrier ribs 16.

Generally, a relatively long process time and a large amount of power are consumed for the baking process. However, in the present exemplary embodiment, because the dielectric paste layer 122 and the barrier rib paste layer 302 are baked through the single baking process, the process time and the power consumption can be reduced.

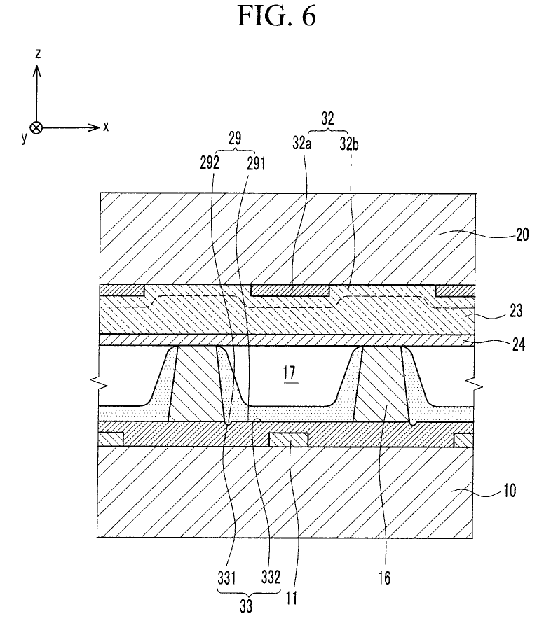

FIG. 6 is a sectional view of a PDP according to a second exemplary embodiment of the present invention. A PDP of the second exemplary embodiment can be manufactured through the above-described method of the present invention. The PDP of the second exemplary embodiment is generally identical or similar to that of the first exemplary embodiment.

A process error occurring in the method of making the PDP is not reflected on the PDP of the first exemplary embodiment. On the other hand, a process error is reflected in the PDP of FIG. 6.

That is, an alignment error may occur between the first resist pattern 214 formed by the first dry film resist 212 and the second resist pattern 414 formed by the second dry film resist 412.

Describing this with reference to FIG. 4 and FIG. 6, the sand particles partially etch the dielectric paste layer 122 that is not covered by the first resist pattern 214 in the barrier rib forming step ST50 due to an alignment error.

Therefore, the first dielectric layer 33 formed by baking the dielectric paste layer 122 includes a groove 331 formed at a side of the discharge cell 17. Considering that the first resist pattern 214 is formed on the dielectric paste layer 122, the groove 331 of the first dielectric layer 33 is formed on an outer area of each discharge cell 17.

In accordance with a direction of the alignment error, the groove 331 may be situated toward a side of the discharge cell 17. Further, the groove 331 formed by over-etching may be formed at both sides of each discharge cell 17 along the outer area.

The groove 331 is formed on a line extending from an inner surface of the barrier rib 16. That is, because the sand particles are induced toward the center of each discharge cell 17 by the barrier rib paste layer 302, the groove 331 is formed on the line extending from the inner surface of the barrier rib 16.

Each of phosphor layers 29 formed on the first dielectric layer 33 and the barrier ribs includes a flat surface and a protrusion 292. The flat surface 291 is formed on the flat surface 332 of the first dielectric layer 33 and the protrusion 292 is formed in the groove 331 of the first dielectric layer 33.

The protrusion 292 is formed on the outer area of the discharge cell 17 and formed with respect to the extending line of the inner surface of the barrier rib 16. The protrusion 292 may be formed to be partly thick so that an amount of the visible light at the thick portion can increase.

As described above, according to the present invention, after the resist pattern is formed on the dielectric paste layer and the barrier rib paste layer is formed using the barrier pattern, the dielectric paste layer and the barrier rib paste layer are baked through a single baking process. Therefore, the process time and power consumption can be reduced. Further, the flat surface of the dielectric layer in the discharge cells makes the thickness of each phosphor layer uniform, thereby the luminance uniformity at the centers of the discharge cell can be improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel comprising:
a first substrate and a second substrate facing the first substrate with an interval therebetween;
an address electrode extending in a first direction on the first substrate;
a dielectric layer on the first substrate covering the address electrode;
one or more barrier ribs on the dielectric layer to define a discharge cell in relation to the address electrode;
a phosphor layer in the discharge cell; and
a first electrode and a second electrode extending in a second direction on the second substrate corresponding to the discharge cell, the second direction crossing the first direction,
wherein the dielectric layer includes a flat surface facing the discharge cell.

2. The plasma display panel of claim 1, wherein the flat surface corresponds to a central portion of the discharge cell.

3. The plasma display panel of claim 1, wherein the dielectric layer includes a groove on at least one side of the discharge cell.

4. The plasma display panel of claim 3, wherein the groove is on an outer area of the discharge cell.

5. The plasma display panel of claim 4, wherein the groove is on a line extending from an inner surface of a barrier rib of the one or more barrier ribs.

6. The plasma display panel of claim 3, wherein the phosphor layer includes a flat surface on the flat surface of the dielectric layer and a protrusion in the groove of the dielectric layer.

7. The plasma display panel of claim 6, wherein the protrusion is on an outer area of the discharge cell.

8. The plasma display panel of claim 7, wherein the protrusion is formed on a line extending from an inner surface of a barrier rib of the one or more barrier ribs.

9. A method of manufacturing a plasma display panel, comprising
preparing a first substrate and a second substrate, and
sealing the first substrate and the second substrate together to face each other with an interval therebetween,
wherein preparing the first substrate comprises:
printing a dielectric paste layer on the first substrate to cover address electrodes on the first substrate;
drying the printed dielectric paste layer;
depositing a first dry film resist on the dielectric paste layer;
forming a first resist pattern on the first dry film resist, the first resist pattern corresponding to a pattern of discharge cells;
printing a barrier rib paste on the first dry film resist;
drying the printed barrier rib paste to form a barrier rib paste layer;
depositing a second dry film resist on the barrier rib paste layer;
forming a second resist pattern on the second dry film resist, the second resist pattern corresponding to a pattern of barrier ribs;
etching the barrier rib paste layer using the second resist pattern to form the barrier ribs;
delaminating the first resist pattern and the second resist pattern; and
baking the dielectric paste layer and the barrier rib paste layer.

10. The method of claim 9, wherein depositing the first dry film resist comprises laminating the first dry film resist on the dielectric paste layer, wherein forming a first resist pattern includes exposing and developing the first dry film resist laminated on the dielectric paste layer.

11. The method of claim 10, wherein depositing the second dry film resist comprises laminating the second dry film resist on the barrier rib paste layer, wherein forming a second resist pattern includes exposing and developing the second dry film resist laminated on the barrier rib paste layer.

12. The method of claim 11, wherein the barrier ribs are formed by removing the barrier rib paste layer using a sandblasting method.

13. The method of claim 12, wherein the dielectric paste layer and the barrier rib paste layer are simultaneously baked through a single baking process.
